(19) United States
(12) Patent Application Publication
(10) Pub. No.: US 2012/0071200 A1
(43) Pub. Date: Mar. 22, 2012

(54) METHOD AND DEVICE FOR SELECTING A SERVING BASE STATION, MOBILE COMMUNICATION NETWORK, BASE STATION, AND METHOD FOR DETERMINING TRANSMISSION CHARACTERISTICS

(75) Inventors: Maik Bienas, Braunschweig (DE); Hyung-Nam Choi, Hamburg (DE)

(73) Assignee: INFINEON TECHNOLOGIES AG, Neubiberg (DE)

(21) Appl. No.: 12/887,570

(22) Filed: Sep. 22, 2010

(51) Int. Cl. H04W 40/12

(52) U.S. Cl. 455/525

(57) ABSTRACT

According to one embodiment, a device for selecting a serving base station of a plurality of base stations of a mobile communication system is described which comprises a receiving circuit configured to receive, for each base station of the plurality of base stations, a message including information related to a possible communication between the base station and a mobile terminal and a selecting circuit configured to select, based on the determined information, a base station of the plurality of base stations that is to provide a communication connection for the mobile terminal.

### TECHNICAL FIELD

Embodiments generally relate to a method and a device for selecting a serving base station, a mobile communication network, a base station, and a method for determining transmission characteristics.

### BACKGROUND

In a heterogeneous communication network, low power nodes such as home base stations or relay nodes may be located in macro radio cell operated by a macro base station. Since low power nodes may share radio resources with each other and with the macro radio cell base station, inter-cell interference may become an issue in such heterogeneous networks. Accordingly, efficient methods for interference mitigation in heterogeneous networks are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a communication system according to an embodiment.

FIG. 2 shows a communication arrangement according to an embodiment.

FIG. 3 shows a communication arrangement according to an embodiment.

FIG. 4 shows a communication arrangement according to an embodiment.

FIG. 5 shows a device for selecting a serving base station of a plurality of base stations of a mobile communication system.

FIG. 6 shows a flow diagram according to an embodiment.

FIG. 7 shows a mobile communication network according to an embodiment.

FIG. 8 shows a flow diagram according to an embodiment.

FIG. 9 shows a base station according to an embodiment.

FIG. 10 shows a flow diagram according to an embodiment.

FIG. 11 shows a subframe allocation according to an embodiment.

FIG. 12 shows a communication system according to an embodiment.

FIG. 13 shows a message flow diagram according to an embodiment.

FIG. 14 shows a message flow diagram according to an embodiment.

FIG. 15 shows a message flow diagram according to an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

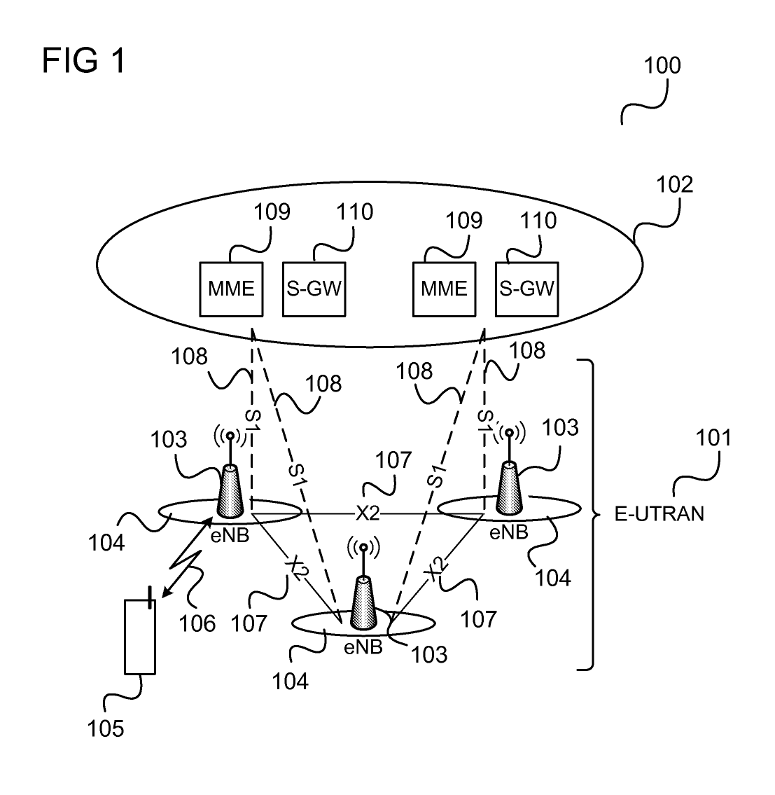

FIG. 1 shows a communication system 100 according to an embodiment.

According to this embodiment, the communication system 100 is configured in accordance with the network architecture of LTE (Long Term Evolution). The communication system 100 may be configured according to other communication standards in other embodiments, e.g. according to UMTS (Universal Mobile Telecommunications Service).

The communication system 100 includes a radio access network (E-UTRAN, Evolved UMTS Terrestrial Radio Access Network) 101 and a core network (EPC, Evolved Packet Core) 102. The E-UTRAN 101 may include base (transceiver) stations (eNodeBs, eNBs) 103. Each base station 103 provides radio coverage for one or more mobile radio cells 104 of the E-UTRAN 101.

A mobile terminal (UE, user equipment) 105 located in a mobile radio cell 104 may communicate with the core network 102 and with other mobile terminals 105 via the base station providing coverage (in other words operating) in the mobile radio cell.

Control and user data are transmitted between a base station 103 and a mobile terminal located in the mobile radio cell 104 operated by the base station 103 over the air interface 106 on the basis of a multiple access method.

The base stations 103 are interconnected with each other by means of the X2 interface 107. The base stations are also connected by means of the S1 interface 108 to the core network (Evolved Packet Core) 102, more specifically to a MME (Mobility Management Entity) 109 and a Serving Gateway (S-GW) 110. The MME 109 is responsible for controlling the mobility of UEs located in the coverage area of E-UTRAN, while the S-GW 110 is responsible for handling the transmission of user data between mobile terminals 105 and core network 102.

In one embodiment, according to LTE, the communication system 100 supports the following types of duplexing methods: full-duplex FDD (frequency division duplexing), half-duplex FDD and TDD (time division duplexing). According to full-duplex FDD two separate frequency bands are used for uplink transmission (i.e. transmission from mobile terminal 105 to base station 103) and downlink transmission (i.e. transmission from base station 103 to mobile terminal 105) and both transmissions can occur simultaneously. According to half-duplex FDD also two separate frequency bands are used for uplink and downlink transmissions, but both transmissions are non-overlapping in time. According to TDD the same frequency band is used for transmission in both uplink and downlink. Within a time frame the direction of transmission may be switched alternatively between downlink and uplink.

The standardization body for mobile communication 3GPP (Third Generation Partnership Project) has specified beside an eNodeB a network element called “Home Node B” (HNB) or “Home eNode B” (HeNB), respectively. The term “Home Node B” (HNB) typically refers to a base station using a radio access technology (RAT) according to UMTS, while the term “Home eNode B” (HeNB) typically refers to a base station using a radio access technology (RAT) according to LTE.

Generally speaking, a HeNB may be seen as a modified eNodeB designed for use in buildings (with focus on home environments) in order to increase the in-building coverage and throughput. It may be seen to be designed to provide radio access in a rather small area of about up to 100 meters, e.g. in a building and also outside the building (e.g. in the near vicinity). Because of the small coverage area, a radio cell provided by a HNBs or a HeNBs may also be referred to as “femto cell”. In contrast to this, a radio cell provided by the regular NodeB may also be referred to as “macro cell”.

A typical use case (i.e. a typical application scenario) may be that a user of a mobile phone operates an HeNB as owner in his apartment. The user for example uses his DSL (Digital Subscriber Line) connection to connect the HeNB to core network of the cellular mobile communication system which he uses (e.g. to which he has subscribed).

The usage of the HeNB may be beneficial for both the operator of the cellular mobile communication system and the user. For example, the user may save money and battery power of his mobile phone by improved in-house coverage when using his HeNB and the operator may get additional network coverage area and may save some energy costs.

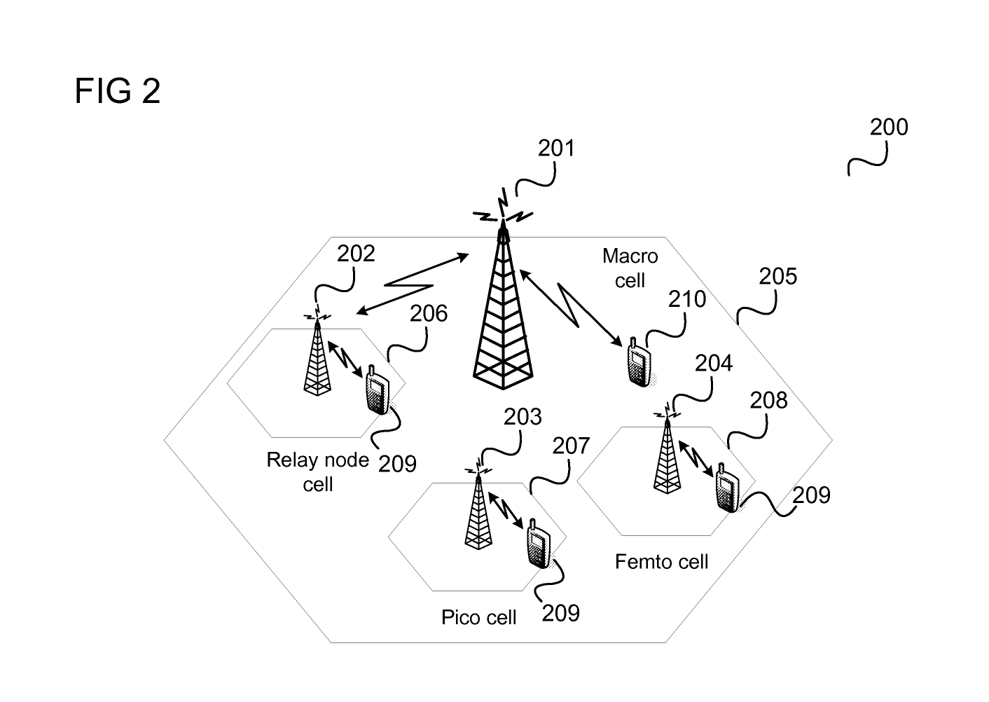

An example for a communication system including low power radio devices operating relatively small radio cells, such as HNBs or HeNBs is shown in FIG. 2.

FIG. 2 shows a communication arrangement 200 according to an embodiment.

The communication arrangement 200 includes a first network node 201, e.g. a first base station, operating a macro cell 205, a second network node 202 implemented by a relay node operating a relay node cell 206, a third network node 203 implemented by a pico eNodeB operating a pico cell 207, and a fourth network node 204, e.g. a home eNodeB, operating a femto cell 208. One or more of the network nodes 201 to 204 may for example correspond to one or more of the base stations 104 in FIG. 1. The relay node cell 206, the pico cell 207, and the femto cell 208 are at least partially located in the macro cell 205. A mobile terminal 210 and other mobile terminals 209 for example corresponding to the mobile terminal 105 in FIG. 1 may communicate with the network nodes 201 to 204 depending on the radio cell or radio cells 205 to 208 in which they are located or on which they are camped on. In this example, the mobile terminal 210 is camped on the macro cell 205 and has for example a connection to the first network node 201 (also referred to as macro cell base station) operating the macro cell 205. The other mobile terminals 209 are for example camped on the relay node cell 206, the pico cell 207, or the femto cell 208.

The geographical position of macro cells of a mobile communication system and the frequency ranges they use are typically determined carefully by the operator of the mobile communication system. This is typically done as part of the network planning. In contrast to this, femto cells are typically placed without network planning and the number of operated femto cells may be much higher than the number of macro cells. Femto cells may lead to interferences between each other and towards the macro cells when they are operated on the same carrier frequency as the macro cells.

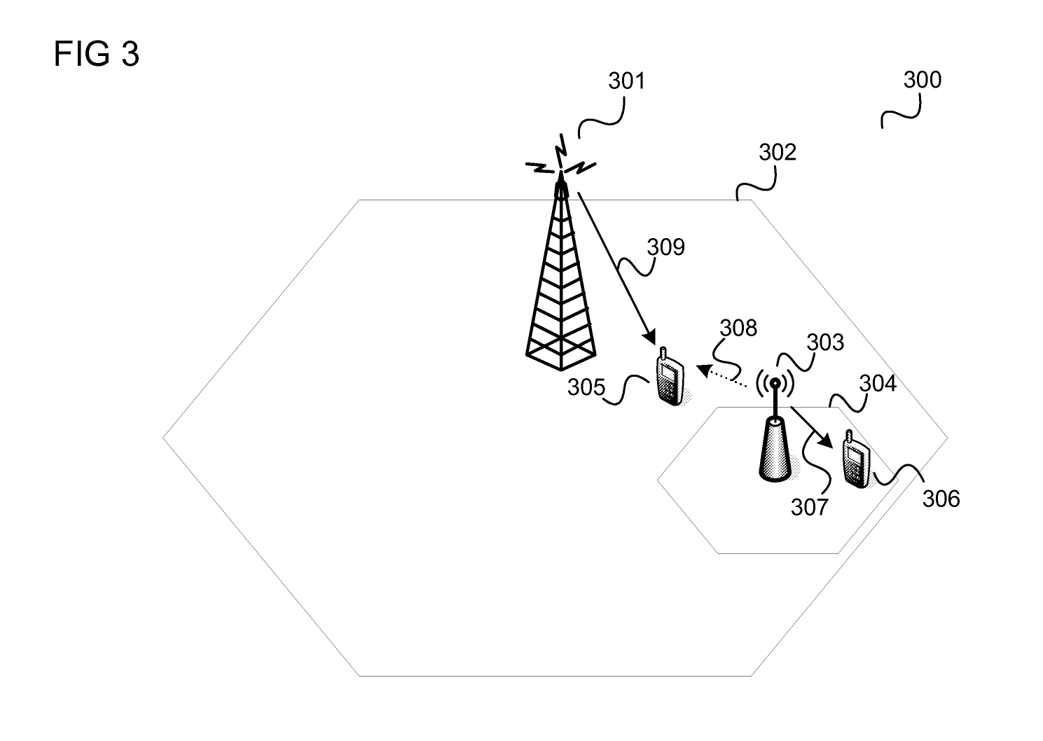

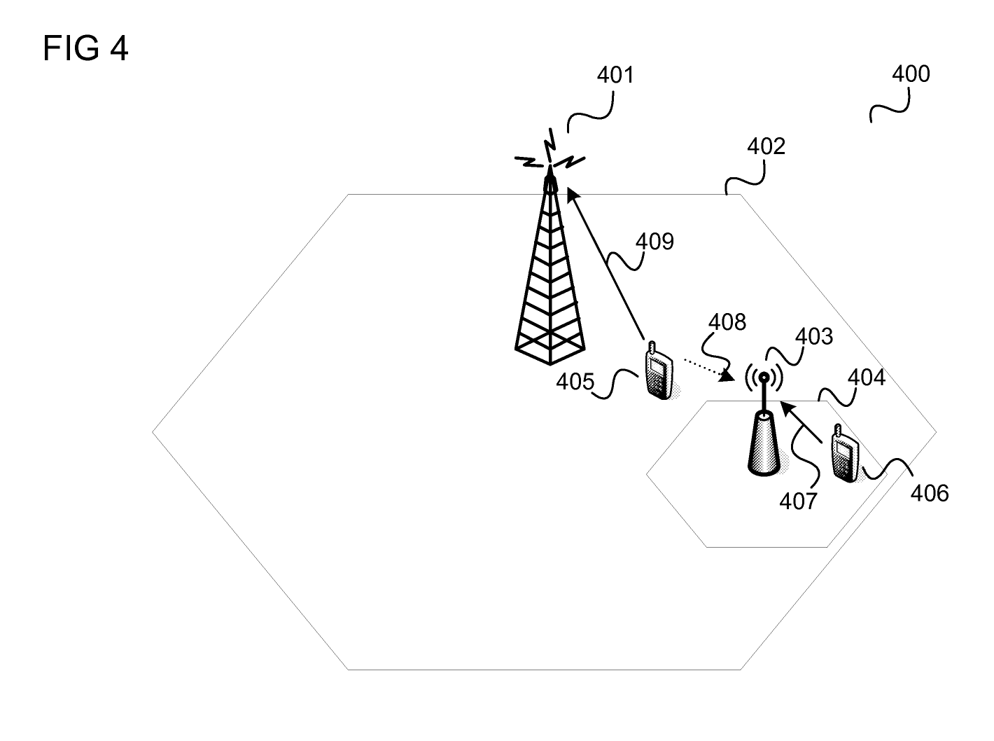

Examples for such interference scenarios are described in the following with reference to FIGS. 3 and 4.

FIG. 3 shows a communication arrangement 300 according to an embodiment. The communication arrangement 300 includes a macro base station 301, e.g. corresponding to the first network node 201 of the communication arrangement 200 illustrated in FIG. 2, operating a macro radio cell 302, and a home eNB 303, for example corresponding to one of the second network node 202, third network node 203, and fourth network node 204 of the communication arrangement 200 illustrated in FIG. 2, operating a femto radio cell 304. A first mobile terminal 305 (macro mobile terminal) is located in the macro radio cell 302 and a second mobile terminal 306 is located in the femto radio cell 304.

It is assumed that the macro base station 301 and the Home eNB 303 are operating on the same carrier frequency or frequencies and that, as illustrated, the coverage areas are overlapping i.e. the femto radio cell 304 at least overlaps with the macro radio cell 302 or is completely located in the macro radio cell 302.

It is further assumed that the macro base station 301 has an ongoing communication connection with the first mobile terminal 305 and that the Home eNB has an ongoing communication connection with the second mobile terminal 306.

As illustrated in FIG. 3, a downlink transmission 307 by the Home eNB 303 may cause interference 308 for a downlink transmission 309 by the macro base station 301 in this example.

Another example for interference in a similar scenario is described in the following.

FIG. 4 shows a communication arrangement 400 according to an embodiment.

The communication arrangement 400 includes a macro base station 401, e.g. corresponding to the first network node 201 of the communication arrangement 200 illustrated in FIG. 2, operating a macro radio cell 402, and a home eNB 403, for example corresponding to one of the second network node 202, third network node 203, and fourth network node 204 of the communication arrangement 200 illustrated in FIG. 2 operating a femto radio cell 404. A first mobile terminal 405 (macro mobile terminal) is located in the macro radio cell 402 and a second mobile terminal 406 is located in the femto radio cell 404.

As in the example described with reference to FIG. 3, it is assumed that the macro base station 401 and the Home eNB 403 are operating on the same carrier frequency or frequencies and that, as illustrated, the coverage areas are overlapping i.e. the femto radio cell 404 at least overlaps with the macro radio cell 402.

It is further assumed that the macro base station 401 has an ongoing communication connection with the first mobile terminal 405 and that the Home eNB 403 has an ongoing communication connection with the second mobile terminal 406.

As illustrated in FIG. 4, an uplink transmission 409 by the first mobile terminal 405 may cause interference 408 for an uplink transmission 407 by a second mobile terminal 406 in this example.

Such interference is typically annoying for the users (e.g. of the first mobile terminal 305, 405 and the second mobile terminal 306, 406) and for the operator of the mobile communication system as it decreases the system throughput and the data rate and typically leads to a waste of mobile terminal battery power and radio resources. In worst case, such interference may result in breaking communication connections (e.g. dropped calls) for both the macro base station 301, 401 and the Home eNB.

The issue of interferences caused by cells operated without network planning is currently studied at 3GPP.

Various concepts may be used for mitigating interference in heterogeneous networks (i.e. cellular mobile communication networks in which different types of base stations such as Home eNBs and macro base stations are deployed), for example:
Power control of Home eNBs: A home eNB may reduce the uplink/downlink transmission power in the femto cell, it operates to mitigate the inter-cell interference to the macro cell in which it is located. This power adaptation may be carried out autonomously by the home eNB based on own measurements, or may be requested by the macro base station of the macro cell. Power control may be used as a simple and straightforward method for mitigating the interference in heterogeneous networks, but may lead to a reduction of the coverage of the femto cell. Further, cell selection is currently typically based on the received signal power. Thus, the strongest cell is typically selected which is fine for well planned networks. However, in case of heterogeneous networks with power controlled HeNBs this may lead to selection of cells producing strongest interferences.
Resource coordination between macro eNB and home eNB: The physical resources (e.g. subframes in time domain, physical resource blocks in frequency domain) may be coordinated/partitioned between a macro eNB and a home eNB located in the macro eNB such that both are communicating using non-overlapping communication resources. This concept may be used as an effective method for mitigating the interference in heterogeneous networks but may lead to degradation of capacity of both the macro eNB and the home eNB. Further, this concept may require a close synchronization between the macro eNB and the home eNB.
Handover of macro UEs to femto cells: Two types of home eNBs may be supported according to LTE: Closed (access mode) home eNBs and Hybrid (access mode) home eNBs. A Closed (access mode) home eNB typically provides services only to its associated CSG (Closed Subscriber Group) UEs, whereas a Hybrid (access mode) home eNB provides services to its associated CSG as well as non-CSG UEs (i.e. to all UEs). These Hybrid (access mode) home eNBs provide a mean for the macro eNB to handover a macro and non-CSG UE located in the vicinity of a hybrid femto cell to the femto cell for interference mitigation purposes. With this concept, the communication performance in the macro cell and of the UE can be improved. On the other hand it may degrade the performance of a Hybrid home eNB providing service to its associated CSG UEs.

The above concepts may be seen to have their merits and drawbacks and thus to leave room for optimization.

According to one embodiment, interference caused by radio cells operated without network planning (e.g. femto cells) on same carrier frequencies as one or more surrounding macro cells is reduced.

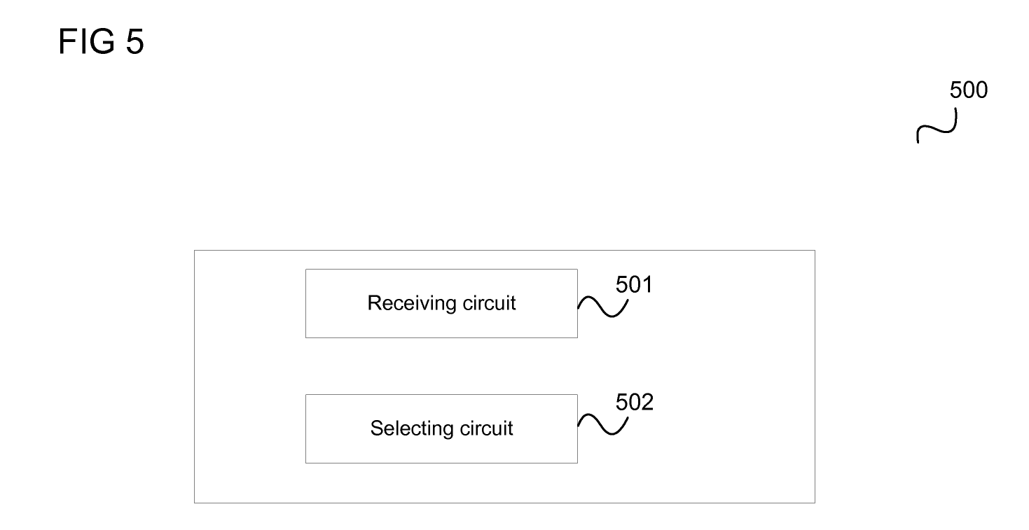

According to one embodiment, a device is provided as illustrated in FIG. 5.

FIG. 5 shows a device 500 for selecting a serving base station of a plurality of base stations of a mobile communication system.

The device 500 includes a receiving circuit 501 configured to receive, for each base station of the plurality of base stations, a message including information related to a possible communication between the base station and a mobile terminal.

Further, the device 500 includes a selecting circuit 502 configured to select, based on the determined information, a base station of the plurality of base stations that is to provide a communication connection for the mobile terminal.

Illustratively, a device, e.g. a network component (for example part of one of the plurality of base stations itself) is provided that collects information, for each of the base stations, e.g. for each possible base station which might be used for providing a communication connection for the mobile terminal, about characteristics of a possible communication between the base station and the mobile terminal. For example, the information is information about a quality that could be achieved if the base station provided the communication connection, wherein the quality may relate to a quality of the communication connection itself (e.g. achievable throughput, achievable signal-to-noise ratio, etc.) or may relate to an overall quality of communication, for example in a radio cell, e.g. may include information indicating the level of interference that would be caused if the base station provided the communication connection. Based on the information, the base station to provide a communciation connection (e.g. a serving base station) is selected.

The information for example includes the distance between the base station and the mobile terminal.

In one embodiment, the selecting circuit is configured to select the base station of the plurality of base stations for which the distance fulfills a predetermined criterion.

For example, the selecting circuit is configured to select the base station of the plurality of base stations for which the determined distance is shortest.

In one embodiment, the information includes the load of a radio cell operated by the base station.

The information for example includes information about the available communication resources of the base station for the communication between the base station and the mobile terminal.

In one embodiment, the information includes information about a transmission characteristic of a communication between the base station and the mobile terminal.

The information may for example include, for the selected base station of the plurality of base stations, information about interference caused by another base station of the plurality of base stations with the communication connection to be provided.

In one embodiment, the device further includes a signaling circuit configured to signal to the other base station to reduce transmission power if the interference with the communication connection caused by the other base station is above a predetermined threshold.

In one embodiment, the mobile communication system includes a macro base station operating a macro radio cell of the mobile communication system and each base station of the plurality of base stations is located within the macro cell.

In one embodiment, each base station of the plurality of base stations operates a radio cell within the macro cell.

For example, for at least one base station of the plurality of base stations, the message is received via radio communication connection.

The device is for example part of one of the base stations of the plurality of base stations. Alternatively, the device may be a (separate) network component of the mobile communication network, such as a (separate) cluster controller as described in more detail below.

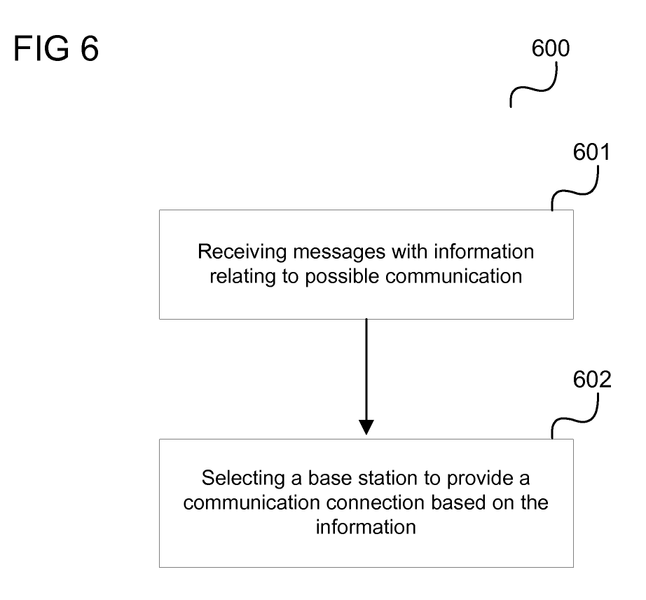

According to one embodiment, the device 500 carries out a method as illustrated in FIG. 6.

FIG. 6 shows a flow diagram 600 according to an embodiment.

The flow diagram 600 illustrates a method for selecting a serving base station of a plurality of base stations of a mobile communication system.

In 601, for each base station of the plurality of base stations, a message is received including information related to a possible communication between the base station and a mobile terminal.

In 602, a base station of the plurality of base stations is selected based on the determined information that is to provide a communication connection for the mobile terminal.

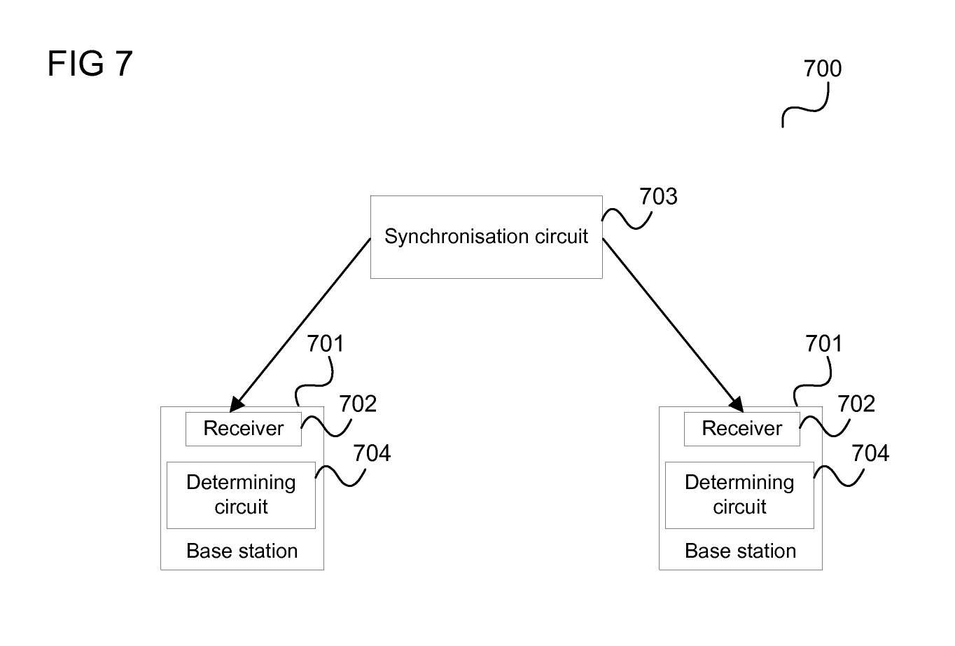

According to one embodiment, a mobile communication network is provided as illustrated in FIG. 7.

FIG. 7 shows a mobile communication network 700 according to an embodiment.

The mobile communication network 700 includes a plurality of base stations 701, wherein each base station 701 of the plurality of base stations 701 includes a receiver 702.

The mobile communication network further includes a synchronization circuit 703 configured to set the receivers 702 of all base stations 701 of the plurality of base stations 701 to receive simultaneously the same signal from a mobile terminal.

Each base station 701 further includes a determining circuit 704 configured to determine, from the received signal, a transmission characteristic of a communication between the base station and the mobile terminal.

Illustratively, a plurality of base stations are configured or set to receive simultaneously the same signal form a mobile terminal for determining a transmission characteristic such that the mobile terminal needs to transmit a signal only once and each base station can determine, for example, a transmission characteristic of a transmission between the base station and the mobile terminal. Accordingly, after only one transmission, characteristics of the communication paths (e.g. the channels) between the mobile terminal and each base station can be determined. The synchronisation circuit 703 may be located in a network component separate from the base stations 701 or may be (at least partially) part of one or more of the base stations 701, i.e. the synchroinsation circuit 703 may for example be located in one of the base stations 701 or may be distributed over two or more base stations 701.

According to one embodiment, the mobile communication network includes a network component and each base station of the plurality of base station include a sending circuit configured to transmit the determined transmission characteristic to the network component.

The network component is for example configured to select a base station of the plurality of base stations that is to provide a communication connection for the mobile terminal.

In one embodiment, the mobile communication network includes a macro base station operating a macro radio cell of the mobile communication system and each base station of the plurality of base stations is located within the macro cell. Each base station of the plurality of base stations for example operates a radio cell within the macro cell.

The synchronization circuit may be configured to set the receivers of all base stations of the plurality of base stations to receive simultaneously the same signal from the mobile terminal using the same communication channel, for example a random access channel. The signal is for example a random access channel preamble.

In one embodiment, the synchronization circuit is configured to set the receivers of all base stations of the plurality of base stations to receive simultaneously the same signal from the mobile terminal using the same communication resources.

In one embodiment, the synchronization circuit is configured to set the receivers of all base stations of the plurality of base stations to receive simultaneously the same signal from the mobile terminal using the same communication time interval.

In one embodiment, the signal is a reference signal, for example a sounding reference signal.

The transmission characteristic for example includes at least one of channel quality information and channel timing information.

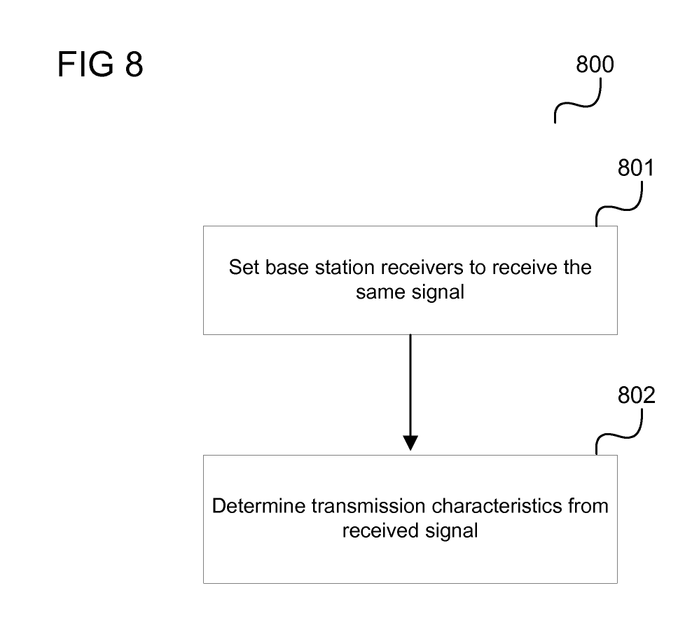

According to one embodiment, a method as illustrated in FIG. 8 is carried out.

FIG. 8 shows a flow diagram 800 according to an embodiment.

The flow diagram 800 illustrates a method for determining transmission characteristics of a mobile communication network including a plurality of base stations, wherein each base station of the plurality of base stations includes a receiver.

In 801, the receivers of all base stations of the plurality of base stations are set to receive simultaneously the same signal from a mobile terminal.

In 802, each base station determines, from the received signal, a transmission characteristic of a communication between the base station and the mobile terminal

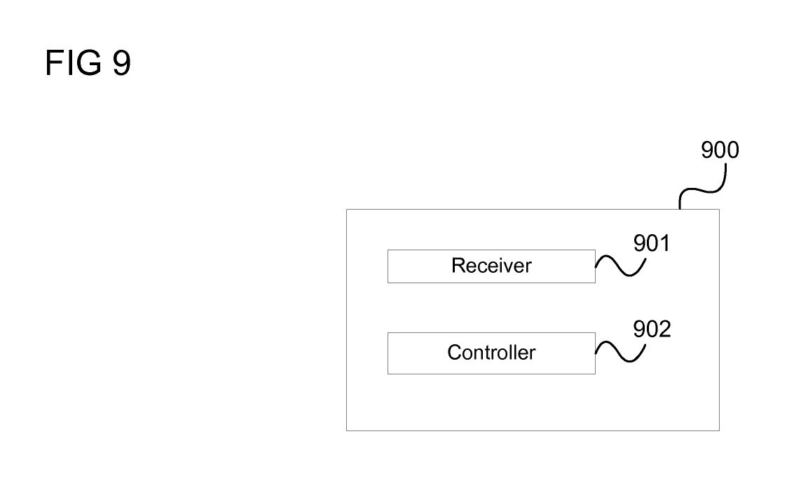

The base station 701, as indicated in FIG. 7, may for example have the structure as illustrated in FIG. 9.

FIG. 9 shows a base station 900 according to an embodiment.

The base station 900 is part of a mobile communication network and including a receiver 901 configured to receive a message specifying that the receiver is to be set such that it receives the same signal that is received by at least one other base station of the mobile communication network.

The base station 900 further includes a controller 902 configured to set the receiver to receive the signal.

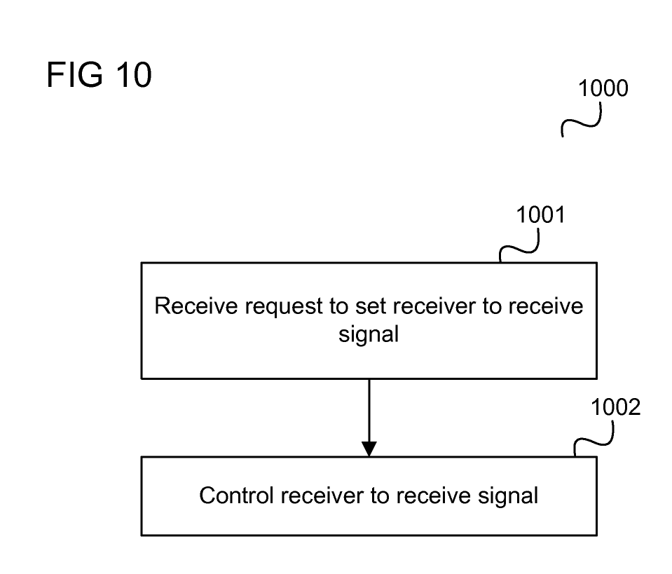

The base station for example carries out a method as illustrated in FIG. 10.

FIG. 10 shows a flow diagram 1000 according to an embodiment.

The flow diagram 1000 illustrates a method for receiving a signal.

In 1001, a base station of a mobile communication network receives a message specifying that the receiver is to be set such that it receives the same signal that is received by at least one other base station of the mobile communication network.

In 1002, the receiver is set to receive the signal.

According to one embodiment, a mobile terminal is provided that includes a determining circuit configured to determine a time interval in which the receivers of a plurality of base stations are set to simultaneously receive a same signal and a sending circuit configured to send a signal within the time interval such that it is received by the plurality of base stations.

The mobile terminal may for example include a receiver configured to receive an indication of the time interval and the determining circuit is for example configured to determine the time interval based on the indication. The indication is for example received from a base station of the plurality of base stations.

According to one embodiment, a method for sending a signal according to the mobile terminal is provided.

It should be noted that embodiments described in context with the method and/or the device for selecting a serving base station are analogously valid for the mobile communication network, the base station, the mobile terminal, and the method for determining transmission characteristics and vice versa.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In various embodiments, the base stations may be configured as a home base station, e.g. as a Home NodeB, e.g. as a Home (e)NodeB. In an example, a ‘Home NodeB’ may be understood in accordance with 3GPP (Third Generation Partnership Project) as a trimmed-down version of a cellular mobile radio base station optimized for use in residential or corporate environments (e.g., private homes, public restaurants or small office areas). In various examples throughout this description, the terms ‘Home Base Station’, ‘Home NodeB’, ‘Home eNodeB’, ‘Femto Cell’, ‘Femto Cell Base Station’ are referring to the same logical entity and will be used interchangeably throughout the entire description. Femto-Cell Base Stations (FC-BS) may be provided in accordance with a 3GPP standard, but may also be provided for any other mobile radio communication standard, for example for IEEE 802.16m.

The so-called ‘Home Base Station’ concept shall support receiving and initiating cellular calls at home, and uses a broadband connection (typically DSL (dynamic subscriber line), cable modem or fibre optics) to carry traffic to the operator's core network bypassing the macro network architecture (including legacy NodeBs or E-NodeBs, respectively), i.e. the legacy UTRAN (UMTS (Universal Mobile Telecommunications System) Terrestrial Radio Access Network) or E-UTRAN, respectively. Femto Cells shall operate with all existing and future handsets rather than requiring customers to upgrade to expensive dual-mode handsets or UMA (Unlicensed Mobile Access) devices.

From the customer's perspective, ‘Home NodeBs’ offer the user a single mobile handset with a built-in personal phonebook for all calls, whether at home or elsewhere. Furthermore, for the user, there is only one contract and one bill. Yet another effect of providing ‘Home NodeBs’ may be seen in the improved indoor network coverage as well as in the increased traffic throughput. Moreover, power consumption may be reduced as the radio link quality between a handset and a ‘Home Base Station’ may be expected to be much better than the link between a handset and legacy ‘NodeB’.

In an embodiment, access to a ‘Home NodeB’ may be allowed for a closed user group only, i.e. the communication service offering may be restricted to employees of a particular company or family members, in general, to the members of the closed user group. This kind of ‘Home Base Stations’ may be referred to as ‘Closed Subscriber Group Cells’ (CSG Cells) in 3GPP. A mobile radio cell which indicates being a CSG Cell may need to provide its CSG Identity to the mobile radio communication terminal devices (e.g. the UEs). Such a mobile radio cell may only be suitable for a mobile radio communication terminal device if its CSG Identity is e.g. listed in the mobile radio communication terminal device's CSG white list (a list of CSG Identities maintained in the mobile radio communication terminal device or in an associated smart card indicating the mobile radio cells which a particular mobile radio communication terminal device is allowed to use for communication). In various embodiments, a home base station may be a consumer device that is connected to the mobile radio core network via fixed line (e.g. DSL) or wireless to a mobile radio macro cell. It may provide access to legacy mobile devices and increase the coverage in buildings and the bandwidth per user. In various embodiments, a home base station may be run in open or closed mode. In closed mode the home base station may provide access to a so-called closed subscriber group (CSG) only. Examples for such closed subscriber groups are families or some or all employees of a company, for example.

As a ‘Femto Cell’ entity or ‘Home Base Station’ entity will usually be a box of small size and physically under control of the user, in other words, out of the MNO's (mobile network operator) domain, it could be used nomadically, i.e. the user may decide to operate it in his apartment, but also in a hotel when he is away from home, e.g. as a business traveler. Additionally a ‘Home NodeB’ may be operated only temporarily, i.e. it can be switched on and off from time to time, e.g. because the user does not want to operate it over night or when he leaves his apartment.

In one embodiment, the concepts of a random access procedure and/or sounding reference signals according to LTE may be used, e.g. in modified form.

A random access procedure may be used a mobile terminal, e.g. for initial access to the network, for re-establishing the connection at a new radio cell after a handover or to derive the timing alignment (TA) value. The timing alignment value may be used by the mobile terminal to adjust the uplink transmission in a way such that it is received by the base station synchronously to a downlink transmission.

A mobile terminal that wants to perform a random access reads first the RACH (Random Access Channel) configuration which is for example broadcast by the base station as part of the system information. The RACH configuration may for example specify which subframes are allowed for RACH transmission (these subframes are typically called “RACH occasions”) and which random access preambles it is allowed to use.

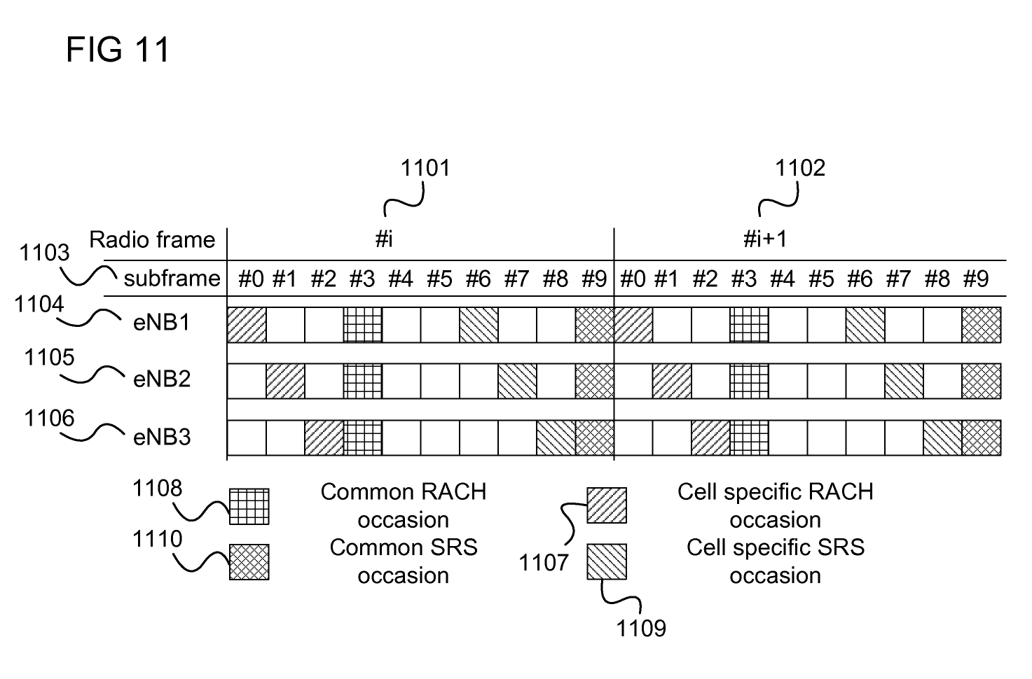

Exemplary configurations for cell specific RACH occasions are illustrated in FIG. 11.

FIG. 11 shows a subframe allocation according to an embodiment.

The subframe is shown for the subframes of a first radio frame 1101 (frame #i) and a subsequent second radio frame 1102 (frame #i+1). The first radio frame 1101 and the second radio frame 1102 both include ten subframes 1103.

The allocation of the subframes is in this example given for a first base station 1104, a second base station 1105, and a third base station 1106, each operating a radio cell and for example corresponding to the second network node 206, the third network node 207, and the fourth network node 208 of the communication system 200 described above with reference to FIG. 2.

In this example, a first hatching 1107 indicates subframes which are allowed for RACH transmissions specifically for each radio cell.

Further, in this example a second hatching 1108 indicates subframes that are commonly allowed for RACH transmissions for all radio cells.

A mobile terminal may randomly select a subframe from the set of allowed subframes and may select a preamble (the preamble may also be selected by the base station and be indicated to the mobile terminal; this is then referred to as “dedicated RACH Preamble”). After that, the mobile terminal transmits the preamble to the respective serving base station. The base station can use the received preamble to calculate the trip time and accordingly the timing alignment value. The base station transmits a random access response back to the mobile terminal that acknowledges the reception of the preamble and including, for example, the timing alignment value. Subsequently, the mobile terminal may transmit a message to the base station with the reason for the request e.g. “RRC connection request” in case of initial access. The base station may then answer again with an acknowledge message and the random access procedure thus ends.

Sounding Reference Signals (SRS) are signals that are transmitted by a mobile terminal to a serving base station. They may be used by the base station to estimate the channel condition of the uplink. Some resources may be reserved for sounding reference signals. The positions of the reserved radio resources (e.g. the position of the reserved subframes within the radio frames) are for example configured by the base station and broadcast as part of the system information. They are also referred to as “SRS occasions” in the following.

In FIG. 11, a third hatching 1109 indicates subframes which are defined as SRS occasions specifically for each radio cell operated by the base stations 1104, 1105, and 1106.

Further, in this example, a fourth hatching 1110 indicates subframes that are commonly defined as SRS occasions for all radio cells.

Whether a mobile terminal should transmit Sounding Reference Signals may be indicated by the base station directly (i.e. via dedicated signalling) to the mobile terminal Based on the channel estimation results, the mobile terminal may select a frequency region that leads to the best transmission performance for the mobile terminal.

According to one embodiment, inter-cell interference caused by radio cells operated on same carrier frequencies as one or more surrounding macro cells (e.g. femto cells operated without network planning) is reduced.

For this, according to one embodiment, several neighbouring radio cells (e.g. femto cells) are combined to a cell cluster, i.e. a cluster of radio cells. For example, radio cells 206, 207, and 208 of the communication system 200 described with reference to FIG. 2 are grouped to a cell cluster.

According to one embodiment, all the base stations operating the cells within the cluster are listening to a common Random Access Channel (RACH) and to common Sounding Reference Signals (SRS) and are using common RACH occasion subframes and common SRS occasion subframes (e.g., in the case of three base stations, the common RACH occasions as indicated by the second hatching 1108 and the common SRS occasions as indicated by the fourth hatching 1110 in FIG. 6) and are using the same configuration for the RACH and the Sounding Reference Signals. For example, the same preamble codes for the RACH are used by all base stations and the same bandwidth is used for the SRS by all base stations. Such common uplink configurations enable all radio cells within the cell cluster to simultaneously measure the signal trip time based on RACH preambles and uplink channel quality based on SRS transmitted by the mobile terminal.

According to one embodiment, all cells within the cell cluster transmit the same common configuration parameters and the same cluster ID as part of the system information broadcast in the cells (by the respective base stations). The common configuration parameters are parameters related to the common RACH and the common SRS configuration. The cluster ID may be used to generate the SRS.

The common configuration parameters are for example broadcast synchronously by all cells within the cluster.

According to one embodiment, all cells within a cluster measure the signal trip time of mobile terminals based on RACH preambles and uplink channel quality based on SRS.

According to one embodiment, a controlling entity, e.g. a controller which is part of a network component, is used to configure a cell cluster and to control handovers between the base stations within the cell cluster.

The controlling entity may select appropriate common configuration parameters for the radio cells of the cell cluster and may transmit them to the base stations operating the cells. For example, parameters are selected by the controlling entity providing sufficient resources for serving a current number of mobile terminals located within the cell cluster, i.e. located in the cells of the cell cluster.

The controlling entity for example receives measurement results from the cells of the cell cluster. It may further receive current capabilities of the base stations (e.g. with regard to abilities to provide a communication connection for a mobile terminal) and take them into account for decision about a handover between the cells of the cluster.

The controlling entity may decide based on the measurement results to re-configure a non-serving cell of the cluster (i.e. a cell operated by a base station that has no ongoing connection towards an mobile terminal) to reduce interference, e.g. by instructing an interfering base station to reduce the transmission power of permanently transmitted channels and signals.

The controlling entity may decides based on the measurement results and the received capabilities to perform a handover from one cell of the cluster to another cell of the cluster, to another cell outside the cluster or from a macro cell to a cell of the cluster.

According to one embodiment, the cluster controller is enabled to decide about handovers based on the signal trip time and on uplink channel quality measured by all cells within the cluster, based on current handover capabilities (e.g. free resources) of one or more cells within the cluster without the need of measurements performed by the mobile terminal.

With grouping of cells to a cell cluster and a controlling entity as described above according to one embodiment, the best suitable serving cell for a terminal (i.e. the cell or, accordingly, the respective base station, providing a communication connection for the mobile terminal) in a heterogeneous network in where many cells are operated in uncoordinated manner and may vary their transmission power regularly may be reliably selected.

It should be noted that measurements that are based only on received power levels may not lead to a selection of cells with lowest interference power. The measurement of the signal trip time and uplink channel quality by all cluster cells according to one embodiment may ensure determination of the best serving cell for each mobile terminal located in the cluster in a resource efficient way and may thus reduce the interference power within the cell cluster significantly. Further, the simultaneous transmission of the common configuration parameters according to one embodiment may reduce inter-cell interference in downlink.

According to one embodiment, several neighboring cells (e.g. femto cells) are summarized to a cell cluster and the cells within the cluster are operated in a synchronous way with respect to the configuration of RACH and SRS. This may enable the base stations operating the cells within the cluster to simultaneously determine the signal trip time and uplink channel quality of each mobile terminal within the cluster. Based on the signal trip time and uplink channel quality a suitable cell within the cluster may be determined for each mobile terminal within the cluster.

Further, according to one embodiment, the base stations operating the cells of the cell cluster report periodically the measured interference level caused by neighboring cells to a controlling entity, e.g. a cluster controller. This may enable the cluster controller to minimize interferences by instructing one or more interfering cell to reduce power, for example of its Broadcast Channel transmissions.

Additionally, according to one embodiment, the cluster controller may receive handover capabilities of one or more base stations operating the cells of the cell cluster prior to a possible handover and may select the best suitable cell for a handover based on the capabilities (e.g. free resources) and based on the measurement results (e.g. signal trip time and uplink channel quality).

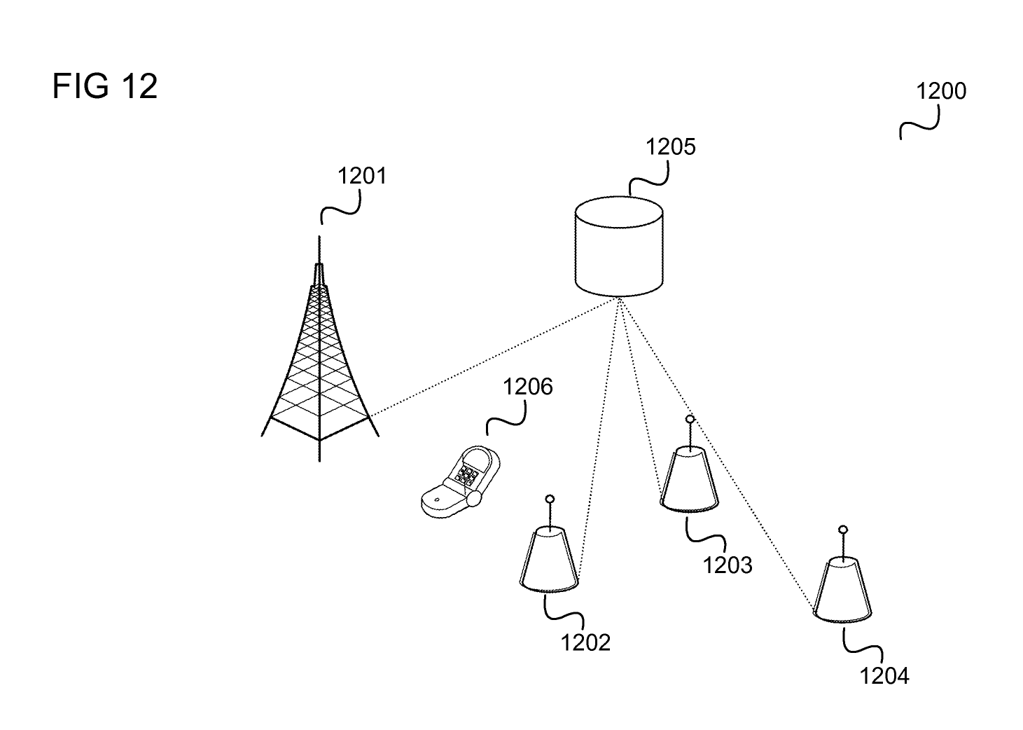

In the following, an embodiment is described in more detail with reference to a communication system as shown in FIG. 12.

FIG. 12 shows a communication system 1200 according to an embodiment.

The communication system 1200 includes a macro base station 1201, a first Home eNB 1202, a second Home eNB 1203, and a third Home eNB 1204. The macro base station 1201 operates a macro radio cell and the Home eNBs 1202, 1203, 1204 are located in the macro radio cell and operate femto cells.

The Home eNBs 1202, 1203, 1204 are grouped to a cell cluster and the communication system 1200 includes a cluster controller 1205 connected to the Home eNBs 1202, 1203, 1204 and the macro base station 1201.

The communication system further includes a mobile terminal 1206 and it is assumed that the mobile terminal 1206 has an ongoing communication connection with the macro base station 1201. It is further assumed that the mobile terminal 1206 moves to the coverage area of the cells of the cell cluster and that the Home eNBs 1202, 1203, 1204 use the same communication resources (e.g. the same carrier frequency or carrier frequencies) for communication within the cells of the cell cluster as the base station 1201 for the communication within the macro cell.

The mobile terminal is configured to report the received power level (RSRP) of some or all of the cluster cells if the RSRP of the macro cell falls below a certain level. It is assumed that this is the case when the mobile terminal moves to the coverage area of the cells of the cell cluster and accordingly significant interferences are perceived and caused by the mobile terminal

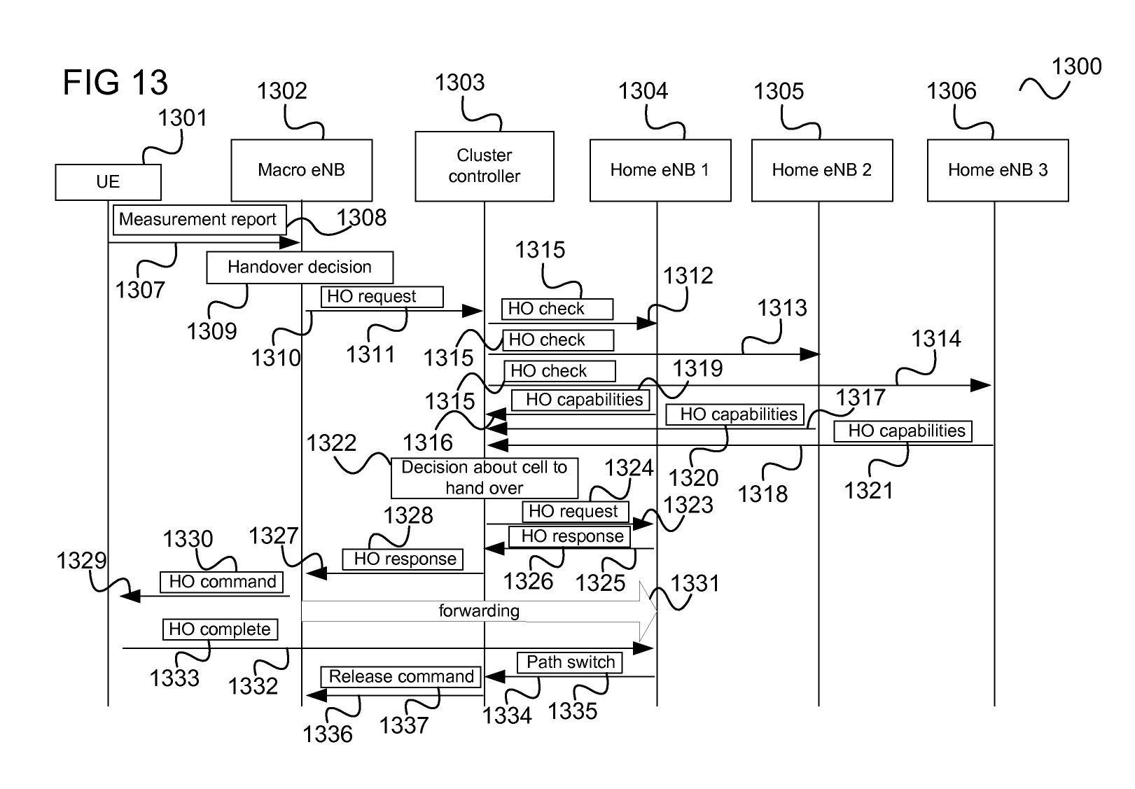

According to one embodiment, the message flow illustrated in FIG. 13 is carried out.

FIG. 13 shows a message flow diagram 1300 according to an embodiment.

The message flow is carried out between a mobile terminal 1301 corresponding to the mobile terminal 1206, a macro base station 1302 corresponding to the macro base station 1201, a cluster controller 1303 corresponding to the cluster controller 1205, a first Home eNB 1304 corresponding to the first Home eNB 1202, a second Home eNB 1305 corresponding to the second Home eNB 1203, and a third Home eNB 1306 corresponding to the third Home eNB 1204.

In 1307, the mobile terminal 1301 reports the measurement results in the form of a measurement report 1308 including an identification of the cluster (cluster ID) to the macro base station 1302.

The macro base station 1302 decides, in 1309, to handover the mobile terminal to the cell cluster. The macro base station 1302 then prepares the handover to the cell cluster. Therefore it transmits, in 1310, a handover (HO) request message 1311 to the cluster controller 1303. Included in the handover request message 1311 are the cell IDs of the cells for which measurements have been reported by the mobile terminal 1301 (i.e. the IDs of the first Home eNB 1304, the second Home eNB 1305, and the third Home eNB 1306).

The reception of the handover request message 1311 triggers the cluster controller 1303 to perform a cluster setup procedure as described below with reference to FIG. 13. In parallel, the cluster controller 1303 performs a joint handover procedure. For this, the cluster controller 1303 transmits, in 1312, 1313, and 1314, a HO check message 1315 to all cells included in the received handover request, i.e. to the of the first Home eNB 1304, the second Home eNB 1305, and the third Home eNB 1306, to analyze their capabilities to operate the current mobile terminal 1301, i.e. to provide a communication connection for the mobile terminal 1301.

The HO check message 1315 includes information about the services currently used by the mobile terminal 1301, e.g. the average data rates in uplink and downlink. The first Home eNB 1304, the second Home eNB 1305, and the third Home eNB 1306 answer in 1316, 1317, and 1318 to the cluster controller 1303 with a respective HO capabilities message 1319, 1320, 1321. A HO capabilities message 1319, 1320, 1321 of a Home eNB 1304, 1305, 1306 includes information whether the Home eNB 1304, 1305, 1306 is able to handle a handover request or not, i.e. whether it is able to take over the communication connection of the mobile terminal 1301.

In 1322, the cluster controller 1303 selects a cell to use for handover. The decision is based on the received HO capabilities messages 1319, 1320, 1321 and on further properties, e.g. the preferences of the subscriber and of the cell owners.

In this example the cluster controller decides, in 1322, to perform a handover to the first base station 1304.

In 1323, the cluster controller 1303 transmits a handover request 1324 including a dedicated RACH preamble to the selected cell, i.e. to the first Home eNB 1304. The first Home eNB 1304 applies the respective configuration and prepares for the handover. In 1325, the first Home eNB 1304 replies to the cluster controller with a first HO response message 1326.

In 1327, the cluster controller 1303 replies to the macro base station 1302 with a second HO response message 1328 and indicates that the handover is prepared. The second HO response message 1328 includes the cell ID of the selected cell, i.e. of the first Home eNB 1304 and a dedicated RACH preamble allocated to the mobile terminal 1301.

In 1329, the macro base station 1302 transmits a HO command message 1330 to the mobile terminal 1301. The HO command message 1330 includes the cell ID of the first Home eNB 1304 and the dedicated RACH preamble.

In 1331, the macro base station 1302 forwards the currently received data for the mobile terminal 1301 to the first Home eNB 1304.

In 1332, the mobile terminal 1301 starts a random access procedure to the first Home eNB 1304 by using the dedicated preamble. After completion of the procedure it transmits a HO complete message 1333 to the first Home eNB 1304.

In 1334, the first Home eNB 1304 transmits a path switch message 1335 to the cluster controller 1303.

In 1336, the cluster controller 1303 transmits a release command message 1337 to the macro base station 1302. This ends the handover procedure.

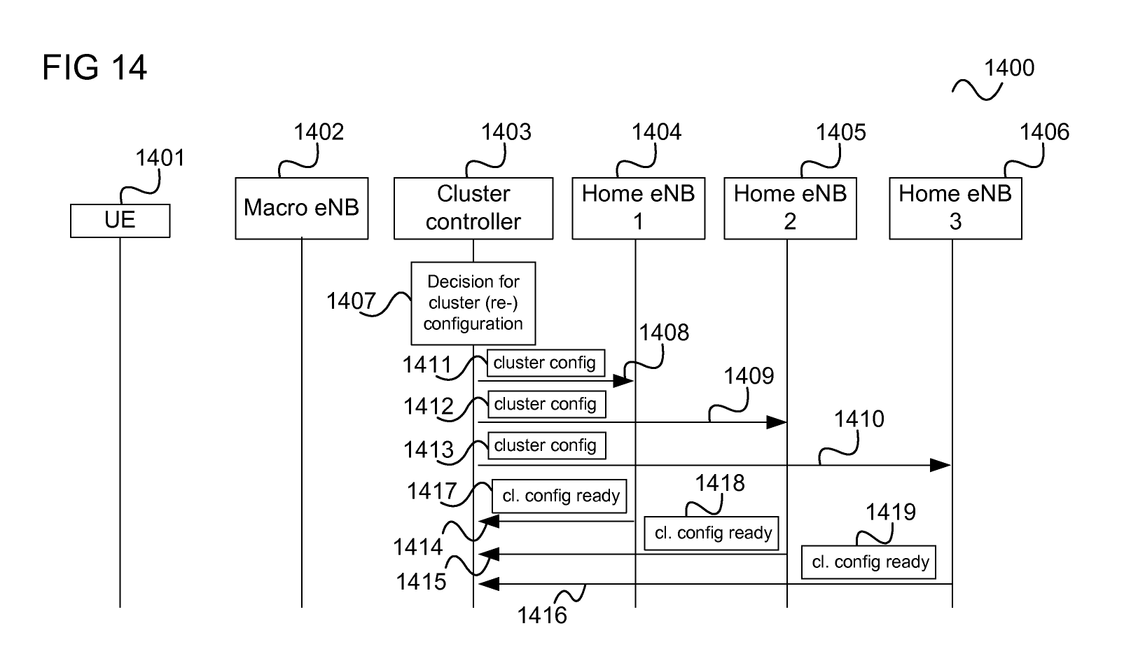

According to one embodiment, the cluster controller 1303 carries out a cluster (re-) configuration procedure. For this, according to one embodiment, the message flow illustrated in FIG. 14 is carried out.

FIG. 14 shows a message flow diagram 1400 according to an embodiment.

The message flow is carried out between a mobile terminal 1401 corresponding to the mobile terminal 1206, a macro base station 1402 corresponding to the macro base station 1201, a cluster controller 1403 corresponding to the cluster controller 1205, a first Home eNB 1404 corresponding to the first Home eNB 1202, a second Home eNB 1405 corresponding to the second Home eNB 1203, and a third Home eNB 1406 corresponding to the third Home eNB 1204.

It is assumed that the cluster controller 1403 is triggered to configure or re-configure a cell cluster. This may for example be because of reception of a HO request message by the cluster controller 1403, e.g. the HO request message 1311, as indicated in FIG. 13, because anew cell is attached or detached to the cluster controller 1403 (i.e. is added to or removed from the cluster) or because a mobile terminal leaves the coverage area of the cell cluster.

In one embodiment, in case a cell cluster is currently configured and the configuration is still usable the cluster controller 1403 does not perform a cluster re-configuration.

In this example it is assumed that the cluster controller 1403 decides, in 1407, to configure anew cell cluster, i.e. that the cell cluster has not yet been configured. It is further assumed that the cluster controller 1403 decides to bundle the first Home eNB 1404, the second Home eNB 1405, and the third Home eNB 1406 to one cell cluster, e.g. due to the fact that it has received the corresponding cell IDs within a HO request message (e.g. the HO request message 1311 of the message flow shown in FIG. 13).

In 1408, 1409, and 1410, the cluster controller 1403 transmits appropriate common settings and a cluster ID to all cells of the cell cluster, i.e. to first Home eNB 1404, the second Home eNB 1405, and the third Home eNB 1406 by means of respective cluster config messages 1411, 1412, 1413.

The common settings for example include parameters for Random Access Channel (RACH), Sounding Reference Signals (SRS) and for the joint uplink measurement procedure. The first Home eNB 1404, the second Home eNB 1405, and the third Home eNB 1406 then start to operate in cluster mode. They apply the settings and start to transmit (e.g. broadcast in their coverage area) the common configuration as indicated by the cluster controller 1403.

In 1414, 1415, 1416, the first Home eNB 1404, the second Home eNB 1405, and the third Home eNB 1406 transmit respective cluster configuration ready messages 1417, 1418, 1419 back to the cluster controller 1403.

In case that a cell should he removed from the cluster, the cluster controller 1403 for example transmits a terminate cluster mode message to the respective Home eNB 1404, 1405, 1406.

The cluster may consist of all cells, of fewer cells, or of more cells as indicated by a mobile terminal entering the cell cluster.

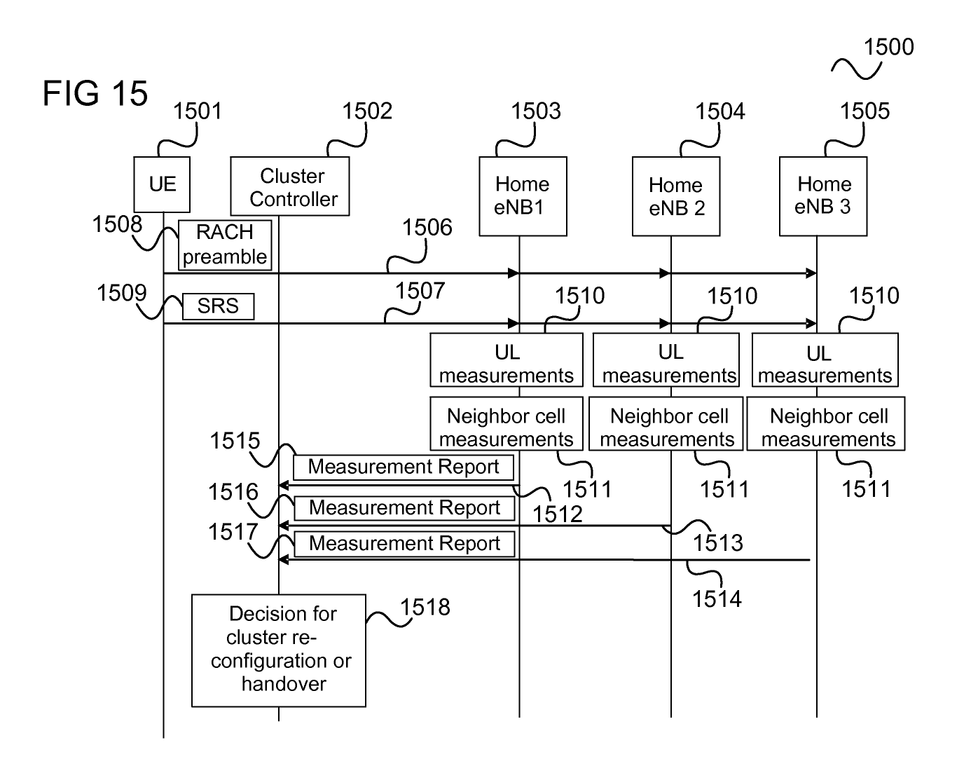

According to one embodiment, a procedure for joint uplink measurements is carried out as illustrated in FIG. 15. This may be seen as an example of a message flow based on a synchronization of a plurality of base stations to receive simultaneously the same signal from a mobile terminal for measurement, e.g. for determining a transmission characteristic of a communication with the mobile terminal.

FIG. 15 shows a message flow diagram 1500 according to an embodiment.

The message flow is carried out between a mobile terminal 1501 corresponding to the mobile terminal 1206, a cluster controller 1502 corresponding to the cluster controller 1205, a first Home eNB 1503 corresponding to the first Home eNB 1202, a second Home eNB 1504 corresponding to the second Home eNB 1203, and a third Home eNB 1505 corresponding to the third Home eNB 1204.

After the mobile terminal 1501 is connected to a cell of the cell cluster, it reads the common settings including the configuration for common RACH and common SRS broadcast in the cell (for example common RACH and SRS occasions as illustrated in FIG. 11).

Further, the mobile terminal 1501 may receive settings from its serving cell via dedicated signaling, e.g. a certain RACH preamble or a certain sequence to use for SRS and time instances when to transmit a RACH preamble or a SRS.

In 1506 and 1507, the mobile terminal 1501 transmits a RACH preamble 1508 and a SRS signal 1509 at the indicated occasions (i.e. the configured common RACH and SRS occasions which are received by the first Home eNB 1503, the second Home eNB 1504, and the third Home eNB 1505.

In 1510, the first Home eNB 1503, the second Home eNB 1504, and the third Home eNB 1505 perform (or at least try to perform) uplink measurements based on the received RACH preamble 1508 and the SRS signal 1509, i.e. to measure the signal trip time and the uplink channel quality.

Further, in 1511, the first Home eNB 1503, the second Home eNB 1504, and the third Home eNB 1505 perform measurements of the received signal power from neighboring cells transmitting on the same frequency, i.e. measure, for example, intra-frequency interference power. The focus of these measurements is for example on the Physical Broadcast Channel (PBCH) and on the Physical Downlink Shared Channel (PDSCH) in case system information is mapped to it.

In 1512, 1513, and 1514, the the first Home eNB 1503, the second Home eNB 1504, and the third Home eNB 1505 transmit the measurement results to the cluster controller 1502 by means of respective measurement report messages 1515, 1516, 1517.

In 1518, the cluster controller 1502 evaluates the measurement results to optimize the ongoing connection and the interferences that are observed within the cluster. It evaluates whether to perform a handover for the mobile terminal 1501 to another cell of the cluster or another cell outside the cluster. For intra-cluster, handover, the decision may take into account the trip time and the uplink channel quality. In case that a handover should take place, the cluster controller 1502 initiates a handover, for example as in 1309 of the message flow described with reference to FIG. 13 but instead of the macro base station 1302 the Home eNB serving the mobile terminal 1501 prior to the handover being involved.

Further, in one embodiment, the cluster controller 1502 evaluates whether to configure the non-serving Home eNBs to reduce interference. For example, Home eNBs with an interference power above a certain value may he regarded as strong interferers. The cluster controller 1502 transmits a message towards these Home eNBs. These Home eNBs reduce the power of the transmitted downlink signals, e.g. permanently transmitted downlink signals such as reference signals, BCH signals, and SCH signals. The power value to which to reduce the transmit power may for example be indicated by the cluster controller 1502. Additionally, the interfering Home eNBs may change the used resources, e.g. start to operate on another carrier frequency, instead of reducing the transmit power.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A device for selecting a serving base station of a plurality of base stations of a mobile communication system, the device comprising:
a receiving circuit configured to receive, for each base station of the plurality of base stations, a message including information related to a possible communication between the base station and a mobile terminal; and
a selecting circuit configured to select, based on the information, a base station of the plurality of base stations that is to provide a communication connection for the mobile terminal.

2. The device according to claim 1, wherein the information comprises the distance between the base station and the mobile terminal.

3. The device according to claim 2, wherein the selecting circuit is configured to select the base station of the plurality of base stations for which the distance fulfills a predetermined criterion.

4. The device according to claim 3, wherein the selecting circuit is configured to select the base station of the plurality of base stations for which the distance is shortest.

5. The device according to claim 1, wherein the information comprises the load of a radio cell operated by the base station.

6. The device according to claim 1, wherein the information comprises information about available communication resources of the base station for a communication between the base station and the mobile terminal.

7. The device according to claim 1, wherein the information comprises information about a transmission characteristic of a communication between the base station and the mobile terminal

8. The device according to claim 1, wherein the information comprises, for the selected base station of the plurality of base stations, an interference caused by another base station of the plurality of base stations with the communication connection to be provided

9. The device according to claim 8, wherein the device further comprises a signaling circuit configured to signal to the other base station to reduce transmission power if the interference with the communication connection caused by the other base station is above a predetermined threshold.

10. The device according to claim 1, wherein the mobile communication system comprises a macro base station operating a macro radio cell of the mobile communication system and each base station of the plurality of base stations is located within the macro radio cell.

11. The device according to claim 10, wherein each base station of the plurality of base stations operates a radio cell within the macro radio cell.

12. The device according to claim 1, wherein for at least one base station of the plurality of base stations, the message is received via a radio communication connection.

13. The device according to claim 1, being a part of one of the base stations of the plurality of base stations.

14. A method for selecting a serving base station of a plurality of base stations of a mobile communication system, the method comprising:
receiving, for each base station of the plurality of base stations, a message including information related to a possible communication between the base station and a mobile terminal; and
selecting, based on the information, a base station of the plurality of base stations that is to provide a communication connection for the mobile terminal.

15. A mobile communication network comprising a plurality of base stations, wherein each base station of the plurality of base stations comprises a receiver, the mobile communication network comprising a synchronization circuit configured to set receivers of all base stations of the plurality of base stations to receive simultaneously a same signal from a mobile terminal; and
each base station comprises a determining circuit configured to determine, from the received signal, a transmission characteristic of a communication between the base station and the mobile terminal

16. The mobile communication network according to claim 15, wherein the mobile communication network comprises a network component and each base station of the plurality of base station comprises a sending circuit configured to transmit the determined transmission characteristic to the network component.

17. The mobile communication network according to claim 16, wherein the network component is configured to select a base station of the plurality of base stations that is to provide a communication connection for the mobile terminal.

18. The mobile communication network according to claim 15, wherein the mobile communication network comprises a macro base station operating a macro radio cell of a mobile communication system and each base station of the plurality of base stations is located within the macro radio cell.

19. The mobile communication network according to claim 18, wherein each base station of the plurality of base stations operates a radio cell within the macro radio cell.

20. The mobile communication network according to claim 15, wherein the synchronization circuit is configured to set the receivers of all base stations of the plurality of base stations to receive simultaneously the same signal from the mobile terminal using same communication resources.

21. The mobile communication network according to claim 15, wherein the synchronization circuit is configured to set the receivers of all base stations of the plurality of base stations to receive simultaneously the same signal from the mobile terminal using a same communication time interval.

22. The mobile communication network according to claim 15, wherein the transmission characteristic comprises at least one of channel quality information and channel timing information.

23. A method for determining transmission characteristics of a mobile communication network comprising a plurality of base stations, wherein each base station of the plurality of base stations comprises a receiver, the method comprising
setting receivers of all base stations of the plurality of base stations to receive simultaneously a same signal from a mobile terminal; and
each base station determining, from the received signal, a transmission characteristic of a communication between the base station and the mobile terminal.

24. A base station of a mobile communication network
comprising a receiver configured to receive a message specifying that the receiver is to be set such that it receives simultaneously a same signal that is received by at least one other base station of the mobile communication network; and
a controller configured to set the receiver to receive the signal.

25. A mobile terminal comprising
a determining circuit configured to determine a time interval in which the receivers of a plurality of base stations are set to simultaneously receive a same signal; and
a sending circuit configured to send a signal within the time interval such that it is received by the plurality of base stations.
